(19) United States
(12) Patent Application Publication
(10) Pub. No.: US 2011/0116224 A1
(43) Pub. Date: May 19, 2011

(54) DOCKING STATION

(75) Inventors: Chih-Chen Lo, Taipei City (TW); Chih-Chin Yu, Taipei City (TW); Yung-Ming Hsia, Taipei City (TW)

(73) Assignee: INVENTEC CORPORATION, Taipei City (TW)

(21) Appl. No.: 12/649,744

(22) Filed: Dec. 30, 2009

(30) Foreign Application Priority Data
Nov. 18, 2009 (TW) 98139203

(51) Int. Cl. G06F 1/16

(52) U.S. Cl. 361/679.41

(57) ABSTRACT

A docking station including a holder, a slider and a sliding plate is provided. The holder has a supporting surface, and both the slider and the sliding plate are movably disposed on the holder, wherein the slider has a plurality of protrusions and the sliding plate has a plurality of rails, and each protrusion on the slider is located correspondingly on one of the rails. When the sliding plate moves in relation to the holder, the protrusions of the slider are guided by the rails of the sliding plate, and a first supporting area and a second supporting area is formed on the supporting surface according to a first position and a second position whereat the slider is located on the supporting surface. The first supporting area is greater than the second supporting area.

### CROSS-REFERENCE TO RELATED APPLICATION

This application claims the priority benefit of Taiwan application serial no. 98139203, filed on Nov. 18, 2009. The entirety of the above-mentioned patent application is hereby incorporated by reference herein and made a part of this specification.

### BACKGROUND OF THE INVENTION

1. Field of the Invention

The present invention generally relates to a docking station, and more particularly, to a docking station applicable to notebook computers with different sizes.

2. Description of Related Art

Usually, a so-called docking station is applicable in a fixed electronic apparatus so as to link a mobile device for interchanging data. The most often available docking station is used by a desktop computer so as to link a mobile apparatus such as mobile phone or personal digital assistant (PDA) to the desktop computer. In other circumstances, the docking station can be used in a fixed output/input apparatus combination as well so that an output/input function of a notebook computer or a PDA is expanded by linking the docking station. In addition, the expanded ports such as USB of a docking station can be also used in an electronic apparatus to link the Internet and storage devices, which covers broad applications.

However, a conventional docking station is used in an electronic apparatus with a predetermined fixed size only, unable in other electronic apparatuses with different sizes although they belong to a same type.

### SUMMARY OF THE INVENTION

Accordingly, the present invention is directed to a docking station applicable to notebook computers with different sizes.

The present invention provides a docking station, which includes a holder, a slider and a sliding plate. The holder has a supporting surface and both the slider and the sliding plate can be movably disposed on the holder, wherein the slider has a plurality of protrusions and the sliding plate has a plurality of rails, and each protrusion on the slider is correspondingly disposed to one of the rails. When the sliding plate moves in relation to the holder, the protrusions of the slider are guided by the rails of the sliding plate, and a first supporting area and a second supporting area of the supporting surface is formed according to whereat a first position and a second position the slider is located on the supporting surface, wherein the first supporting area is greater than the second supporting area.

In an embodiment of the docking station of the present invention, the above-mentioned holder has a side surface, and the side surface has an included angle with the supporting surface and the included angle is greater than or equal to 90°. In addition, the docking station further includes a slide-button connected to the sliding plate. The side surface has an opening, and the slide-button is disposed in the opening. The slider has two protrusive portions. When the slider is located at the first position, the protrusive portions are flashed with the side surface or caved from the side surface; when the slider is located at the second position, the protrusive portions are protruded from the side surface.

In an embodiment of the docking station of the present invention, the above-mentioned rails are parallel to each other, and the length direction of the rails includes an acute angle with the moving direction of the protrusive portions.

Based on the mention above, the sliding plate of the docking station of the present invention can drive the slider to slide on the holder so as to adjust the supporting area of the supporting surface of the holder. In this way, a user is required to move the sliding plate only to adjust the position of the slider on the holder so that the supporting area of the supporting surface can suit notebook computers with different sizes and the docking station of the present invention thereby obtains great usage convenience.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a docking station according to an embodiment of the present invention.

FIG. 2 is a diagram of the docking station of FIG. 1 where the slider is located at the second position.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

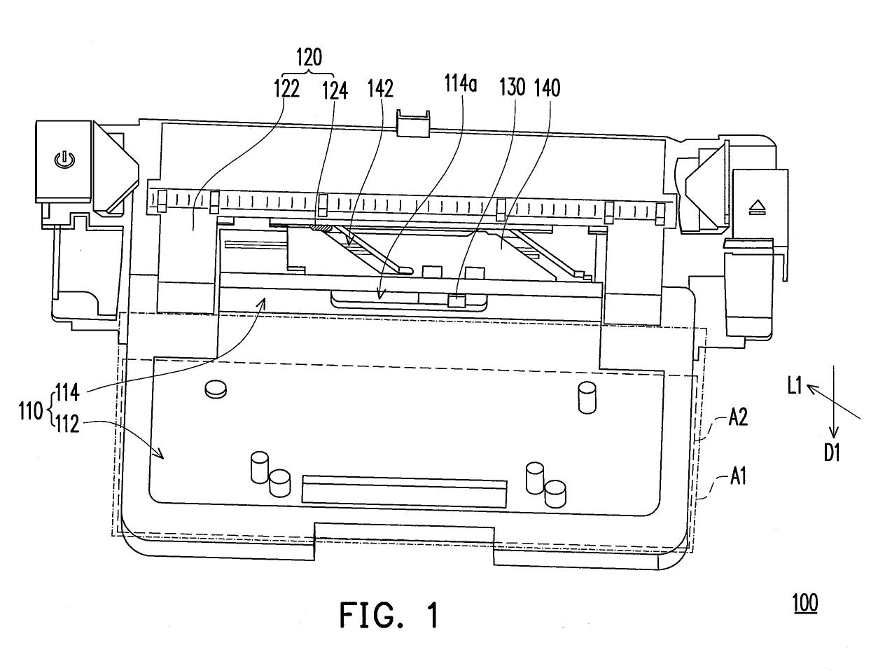

FIG. 1 is a diagram of a docking station according to an embodiment of the present invention. Referring to FIG. 1, a docking station 100 of the embodiment suits supporting a notebook computer, wherein the docking station 100 includes a holder 110, a slider 120 and a sliding plate 140. The holder 110 has a supporting surface 112, and both the slider 120 and the sliding plate 140 are movably disposed on the holder 110, wherein the slider 120 has a plurality of protrusions 124 and the sliding plate 140 has a plurality of rails 142. Each of the protrusions 124 is correspondingly located on one of the above-mentioned rails 142. When the sliding plate 140 moves, the slider 120 can respectively located at a first position and a second position on the supporting surface 112 through the matches between the rails 142 of the sliding plate 140 and the protrusions 124 of the slider 120. Then, a first supporting area A1 and a second supporting area A2 are respectively formed on the supporting surface 112 according to the first position and the second position whereat the slider 120 is located, and the first supporting area A1 is greater than the second supporting area A2. The different supporting areas of the supporting surface 112 of the holder 110 of the docking station 100 enables notebook computers with different sizes firmly placed thereon.

The holder 110 further has a side surface 114 and the side surface 114 has an included angle with the supporting surface 112, wherein the included angle can be greater than or equal to 90° depending on the actual requirement. When the included angle is 90°, the design facilitates a notebook computer to be combined with the docking station 100; when the included angle is an obtuse angle, the design can avoid the notebook computer and the docking station 100 from being interfered therebetween during the above-mentioned combination.

In addition, the docking station 100 further includes a slide-button 130 linked to the sliding plate 140. The side surface 114 has an opening 114a and the slide-button 130 can be accommodated in the opening 114a. The slider 120 has two protrusive portions 122 and a plurality of protrusions 124, wherein the protrusive portions 122 are located on the supporting surface 112 and the protrusions 124 are located on the corresponding rails 142 of the holder 110. The rails 142 are parallel to each other, and in the embodiment, the length direction L1 of the rails 142 includes an acute angle with the moving direction D1 of the protrusive portions 122.

Referring to FIG. 1, when the slider 120 is located at the first position, the protrusive portions 122 are flashed with the side surface 114. In other embodiments, the protrusive portions 122 can be caved from the side surface 114 depending on the design demand. At the time, the supporting surface 112 has the first supporting area A1 and the supporting surface 112 can support a notebook computer with larger size.

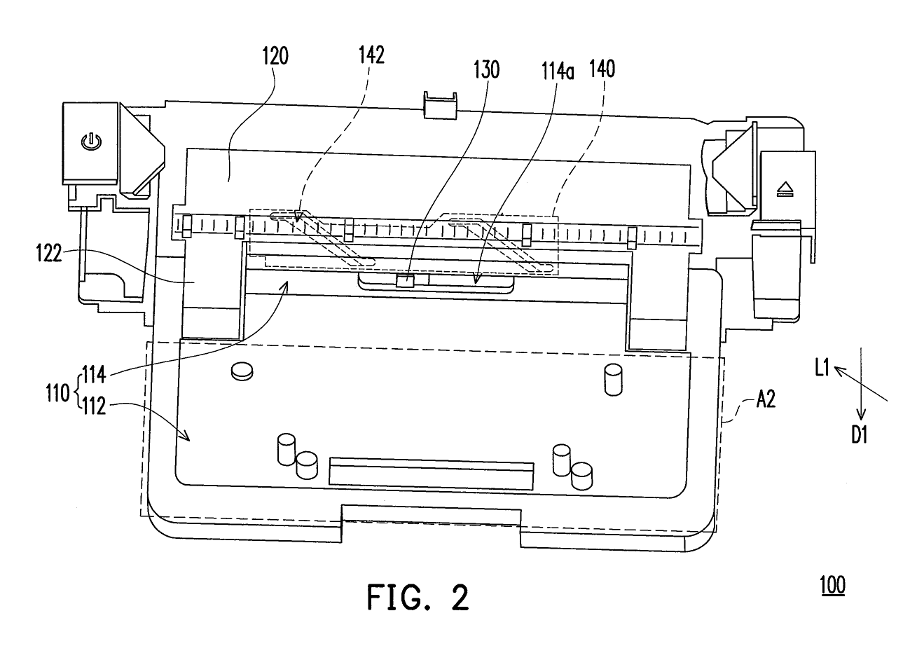

FIG. 2 is a diagram of the docking station of FIG. 1 where the slider is located at the second position. Referring to FIGS. 1 and 2, when the user wishes to use a notebook computer with smaller size, if the notebook computer with smaller size is directly disposed on the supporting surface 112 of the docking station 100 having the first supporting area A1, the notebook computer with smaller size can not be properly supported due to no appropriate structure is available for supporting, so that the notebook computer with smaller size can not be firmly fixed on the docking station 100. In short, the docking station 100 having the first supporting area A1 is not suitable for the notebook computer with smaller size.

The user can directly push the slider 120 or push the slide-button 130 by hand to move the slide-button 130 in the opening 114a. Driven by the slide-button 130, the sliding plate 140 moves leftwards in relation to the holder 110. Then, the protrusions 124 of the slider 120 are forced by the rails 142 of the sliding plate 140 to bring the protrusive portions 122 moving along the moving direction D1 on the supporting surface 112 until the slider 120 is located at the second position, where the protrusive portions 122 are protruded from the side surface 114. At the time, the supporting surface 112 has the second supporting area A2 with a smaller area.

When the user inserts a notebook computer with smaller size into the docking station 100 as shown by FIG. 2, the notebook computer with smaller size gets support due to the protrusive portions 122 are protruded from the side surface 114, and the notebook computer with smaller size can be fixed on the docking station 100.

Although the embodiment enables the slider 120 to be at the first position and the second position so as to make the two supporting areas with different areas of the supporting surface for supporting two different sizes of the notebook computers, but anyone skilled in the art can make the slider move on the supporting surface in step manner to form a plurality of different supporting areas and thereby to make the docking station be shared for different notebook computers with different sizes. Besides, the disposition direction of the rails of the sliding plate can be varied with the application demand, which the present invention is not limited to. Within the spirit of the present invention, even the rails of the sliding plate and the protrusions of the slider can be replaced by other appropriate structures.

In summary, the docking station of the present invention is able to change the supporting area of the supporting surface to suit different notebook computers with different sizes and then can be commonly used. For a user, the docking station of the present invention is advantageous not only in great usage convenience, but also in saving the cost for purchasing a plurality of docking stations suitable for the notebook computers with different sizes.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A docking station, comprising:
a holder, having a supporting surface;
a slider, movably disposed on the holder and having a plurality of protrusions; and
a sliding plate, movably disposed on the holder and having a plurality of rails, wherein each of the protrusions on the slider is correspondingly located on one of the rails so that when the sliding plate moves in relation to the holder, the protrusions of the slider are guided by the rails of the sliding plate, and a first supporting area and a second supporting area of the supporting surface are correspondingly formed according to a first position and a second position whereat the slider is located on the supporting surface, wherein the first supporting area is greater than the second supporting area.

2. The docking station as claimed in claim 1, wherein the holder has a side surface and the side surface has an included angle with the supporting surface.

3. The docking station as claimed in claim 2, wherein the included angle is greater than or equal to 90°.

4. The docking station as claimed in claim 2, further comprising a slide-button connecting the sliding plate, wherein the side surface has an opening and the slide-button is disposed in the opening.

5. The docking station as claimed in claim 4, wherein the slider has two protrusive portions, when the slider is located at the first position, the protrusive portions are flashed with the side surface or caved from the side surface; when the slider is located at the second position, the protrusive portions are protruded from the side surface.

6. The docking station as claimed in claim 1, wherein the rails are parallel to each other.

7. The docking station as claimed in claim 6, wherein a length direction of the rails includes an acute angle with a moving direction of the protrusive portions.
